(19) United States
(12) Patent Application Publication
(10) Pub. No.: US 2013/0276830 A1
(43) Pub. Date: Oct. 24, 2013

(54) N-propyl Bromide Based Solvent Compsitions And Methods for Cleaning Articles

(71) Applicants: Keiji Ando, Yokohama-shi (JP); Hisashi Miwa, Setagaya-ku (JP)

(72) Inventors: Keiji Ando, Yokohama-shi (JP); Hisashi Miwa, Setagaya-ku (JP)

(73) Assignee: Albemarle Corporation, Baton Rouge, LA (US)

(21) Appl. No.: 13/994,957

(22) PCT Filed: Dec. 12, 2011
(86) PCT No.: PCT/US11/64351

§ 371 Date: Jun. 17, 2013

Related U.S. Application Data
(60) Provisional application No. 61/424,124, filed on Dec. 17, 2010.

(51) Int. Cl. C11D 3/43

(52) U.S. Cl. CPC C11D 3/43
USPC 134/10; 510/505; 510/490; 510/506; 510/109; 510/244; 510/273

(57) ABSTRACT

n-Propyl bromide based solvent compositions and methods for cleaning articles using said solvent compositions are provided. Such solvent composition comprise about 50 weight percent to 99 weight percent of n-propyl bromide, about 0.5 weight percent to 50 weight percent of alcohol, and at least 0.005 weight percent of a surfactant. Such solvent compositions remove at least one of water or water soluble contaminants. The solvent compositions and methods of the present invention are useful as a degreaser and/or cleaner in both for cold cleaning and hot rinsing systems for cleaning articles.

### FIELD OF THE INVENTION

The present invention generally relates to the field of cleaning articles using n-propyl bromide-based solvent compositions.

### BACKGROUND

A variety of methods and solvent compositions are known for cleaning articles such as metals, aerospace components, medical devices, photographic and movie films, electronic and mechanical parts, molds for casting plastics, surfaces being prepared for painting, and various substrates in need of degreasing, including plastic and elastomeric surfaces. While chlorine-containing solvents are technically suitable for cleaning articles, many of them have now been severely restricted because of environmental and/or health considerations. The need for a non-chlorinated high-performance cleaning agent that could be used in a safe and efficient manner has led to the development of n-propyl bromide solvent compositions.

n-Propyl bromide (also referred to as 1-bromopropane, propyl bromide or NPB) is now recognized as being an environment-friendly solvent. It is a commercial product, used particularly in cold cleaning and/or vapor degreasing processes. Solvent compositions comprising n-propyl bromide, and an additive/stabilizer are well known in the art. Some of the commonly used additives/stabilizers include naphtha, nitrile, ketones, esters, glycols, ethers, carbonates, glycolic acids, alkaline hydroxides, amines, epoxides, nitroalkanes and mixtures thereof. These and other methods, however, are not suitable for removing at least one of water or water-soluble contaminants

Water has a very low solubility in n-propyl bromide. Therefore, when cleaning articles having water and/or water-soluble surface contaminants, typically an n-propyl bromide-based solvent is mixed with water by agitation in an attempt to remove such surface contaminants. However, the NPB and water mixture easily forms an emulsion that is difficult to separate. Decomposition of n-propyl bromide is another concern with existing n-propyl bromide-based solvent systems. n-Propyl bromide reacts with water easily and if there is an excess of water in an n-propyl bromide based solvent, the n-propyl bromide decomposes at more than five times its normal decomposition rate. Further, the waste treatment for an emulsion of n-propyl bromide, water, and surfactants requires much energy, and is equipment intensive.

Thus, there is a need for an n-propyl bromide-based solvent for removing water and/or water-soluble surface contaminants, which solvent possesses good separability features and has a relatively low rate of decomposition on reacting with water.

### SUMMARY OF THE INVENTION

This invention provides such solvent compositions comprising about 50 weight percent to about 99 weight percent n-propyl bromide, about 0.5 weight percent to about 50 weight percent alcohol. and at least 0.005 weight percent of surfactant.

This invention provides methods for removing at least one of water or water-soluble contaminants from articles. Such methods utilize solvent compositions comprising about 50 weight percent to about 99 weight percent n-propyl bromide, about 0.5 weight percent to about 50 weight percent alcohol. and at least 0.005 weight percent of surfactant.

Solvent compositions and methods of the present invention are used for removal of at least one of water or water-soluble contaminants from metal products, glass products, plastics, polymeric substrates, electronic components, and combinations thereof.

Solvent compositions and methods of the present invention are useful for cleaning. As used herein, the term “cleaning” means cold cleaning and/or hot rinsing; the term “cold cleaning” means rinsing with a solvent at ambient temperature; and the term “hot rinsing” means rinsing with condensed solvent. Herein, the terms “solvent” and “solvent composition” are used interchangeably.

Further features and advantages of the present invention are described in detail below with reference to the accompanying examples.

### DETAILED DESCRIPTION

The present invention provides n-propyl bromide-based solvent compositions and methods for cleaning articles. The solvent compositions of the invention comprise about 50 weight percent to about 99 weight percent of n-propyl bromide, about 0.5 weight percent to about 50 weight percent of alcohol, and at least about 0.005 weight percent of surfactant. The solvent compositions and associated cleaning methods of this invention are useful in the removal of at least one of water or water-soluble contaminants from an article. In various aspects of the present invention, the cleaning is performed by cold cleaning or hot rinsing methods.

The amount of n-propyl bromide used in solvent compositions of this invention can be about 80 weight percent to about 98 weight percent, or about 88 weight percent to about 95 weight percent.

The alcohol for use in solvent compositions of this invention is an aliphatic monohydric alcohol. The alcohol can be selected from the group consisting of 1-propanol, isopropyl alcohol, 1-butanol, 2-butanol, isobutyl alcohol, tertiary butyl alcohol, 1-heptanol, 1-hexanol and pentanol, including mixtures thereof.

Surfactants for use in the solvent composition of this invention can be selected from the group consisting of non-ionic surfactants, a product of reaction between a fatty acid reactant and an amine reactant (fatty acid-amine), including mixtures thereof. The fatty acid reactant can be selected from the group consisting of C₆ to C₁₂-containing aliphatic monocarboxylic acid, including mixtures thereof. The fatty acid can be hexanoic acid or decanoic acid. The amine reactant used in this invention can be selected from the group consisting of C₆ to C₁₂-containing aliphatic monoamines, including mixtures thereof. The amine can be laurylamine. The fatty acid-amine produced by equivalent reaction between fatty acid and amine can be a compound produced by equivalent reaction between hexanoic acid and oleylamine, or a compound produced by equivalent reaction between decanoic acid and oleylamine, or a compound produced by equivalent reaction between hexanoic acid and laurylamine, or a compound produced by equivalent reaction between decanoic acid and laurylamine.

The non-ionic surfactants for use in this invention can be selected from the group consisting of polyoxyethylene alkyl ether, polyoxyethylene sec-alcohol ether and polyoxyethylene alkyl phenyl ether, including mixtures thereof. For example, SOFTANOL may be used.

A non-ionic surfactant that is biodegradable, such as, polyoxyethylene sec-alcohol ether, is useful in this invention. The concentration of the non-ionic surfactant in solvent compositions of this invention can be about 0.5 weight percent, or about 0.5 weight percent to under 1 weight percent.

Solvent compositions of this invention are suitable for removal of at least one of water or water-soluble contaminants from articles using cold cleaning process. The article is contacted with the solvent of this invention in order to remove contaminating residues. The article is immersed in the solvent of this invention or a jet stream of a solvent of this invention is sprayed on the article.

The methods presented herein may be used for cleaning a variety of articles. Non-limiting examples of articles include metal products, glass products, plastics, polymeric substrates, electronic components or articles, and combinations thereof.

In methods of this invention, the cleaning can be achieved by contacting the article in a sump containing the solvent composition. The article can optionally be subjected to ultrasonic agitation, or contacted with a jet stream of the solvent composition. In another aspect, the said solvent composition is sprayed on the articles prior to degreasing.

Methods of the present invention are suitable, e.g., for use in cold cleaning applications for removing at least one of water or water soluble contaminants from the article. The cold cleaning of articles is typically performed at ambient temperature, e.g., up to about 55 degrees C. Cold cleaning is usually characterized by the immersion and soaking of the article to be cleaned in the solvent composition with or without agitation. Articles which are too large to be immersed may be sprayed with the solvent composition. Ultrasonics may be used in conjunction with the cold cleaning for removing at least one of water or water-soluble contaminants from deep recesses or other inaccessible areas.

In another aspect, methods of the present invention are suitable for use in hot rinsing for drying. Ultrasonics may optionally be used in conjunction with the hot rinsing for removing at least one of water or water-soluble contaminants from deep recesses or other inaccessible areas.

In yet another aspect, the hot rinsing application rinser is provided with a set of cooling coils near its top. The cooling coils contact the solvent vapor before it escapes from the unit, which causes cooling and condensation of the vapor. The vapor condensate flows back to a clean tank wherein the solvent. At least one of water or water-soluble contaminants is separated by using various separation methods including without limitation, membrane separation and/or gravity separation.

Methods of the present invention offers several advantages over existing methods and these will be described in greater detail by way of specific examples. The following examples are offered for illustrative purposes, and are not intended to limit the invention in any manner.

One of the advantages of the present invention is that the solvent composition used in the methods of the present invention does not form emulsions even in presence of excess of water, which results in methods of this invention providing removal of at least one of water or water-soluble contaminants, and at the same time gives good separation between water phase and solvent phase.

Yet another advantage is that solvent compositions of the present invention can easily and rapidly remove water or water-soluble contaminants from articles without undergoing rapid decomposition in presence of water.

### EXAMPLES

The following examples are illustrative of the principles of this invention. It is understood that this invention is not limited to any one specific embodiment exemplified herein, whether in the examples or the remainder of this patent application.

### Example 1

Experiments were conducted, at room temperature, in order to assess the rinseability of solvent compositions of the present invention. Solvent compositions of this invention were prepared by combining the n-propyl bromide and alcohol in the weight percents shown in Table 1 to form a first composition, then by adding the surfactant to the first composition in the weight percent shown in Table 1. In these experiments, freshly prepared glass beads, having a diameter of 2 mm, were put into a 25 ml measuring cylinder, and 2 ml water was added to the glass beads. Each solvent of the present invention shown in Table 1 was then added to the measuring cylinder containing glass beads and water. The volume of the water phase was measured after 5 minutes. A water phase volume of 0.5 ml or more was considered as a positive test for rinseability, with increasing volumes indicating better rinseability. The results of this test are summarized in Table 2.

### Example 2

As in Example 1, experiments were conducted, at room temperature, in order to evaluate the separability of the solvents of the present invention. In these experiments, 10 ml of each solvent showed Table 1 was poured into a 100 ml glass bottle. 2 ml of water was added to the solvent, then the bottle was capped, and shaken in order to mix the solvent and water. Absence of emulsion was considered as a positive test for separability. The results of this test are also summarized in Table 2.

TABLE 1

| First Composition | | | | Surfactant | | |
|---|---|---|---|---|---|---|
| | n-Propyl | Alcohol (weight | | Fatty acid-amine product | | SOFT- |
| | bromide | percent) | | (weight percent) | | ANOL 70 |
| | (weight | | 1- | Hexanoic acid | Decanoic acid | (weight |
| No. | percent) | 1-Propanol | Butanol | lauryl amine | lauryl amine | percent) |
| 1 | 90 | 10 | — | 0.2 | — | — |
| 2 | 90 | — | 10 | 1 | — | — |
| 3 | 80 | 20 | — | 1 | — | — |
| 4 | 60 | 40 | | 1 | — | — |
| 5 | 98 | 2 | — | 1 | — | — |
| 6 | 90 | 10 | — | 0.5 | — | 0.25 |
| 7 | 90 | 10 | — | — | 1 | — |
| 8 | 90 | | 10 | 0.01 | — | — |

TABLE 2

| | Rinseability | Separability¹ |
|---|---|---|
| No. | (Ex. 1) | (Ex. 2) |
| 1 | 1.4 | Yes |
| 2 | 1.8 | Yes |
| 3 | 1.8 | Yes |
| 4 | 1.8 | Yes |
| 5 | 1.4 | Yes |
| 6 | 1.8 | Yes |
| 7 | 1.4 | Yes |
| 8 | 1.4 | Yes |

¹Yes = No emulsion is formed

### Example 3

The decomposition rate of the mixture of 90 weight percent of n-propyl bromide and 10 weight percent of n-propyl alcohol was measured by determining the consumption rate of 1,2-butylene oxide. 1,2-butylene oxide was added to the mixture of n-propyl bromide and n-propyl alcohol in order to achieve a final concentration of 0.5 weight percent, and poured in equal volumes into two 100 ml sample bottles. 2 g and 0.1 g water was poured into each sample bottle. The sample was kept at 35 degrees Centigrade. An aliquot was taken from the sample bottle and analyzed, for consumption of 1,2-butylene oxide by means of a gas chromatograph. The results are presented in Table 3.

TABLE 3

| | Water content | Consumption rate of 1,2- |
|---|---|---|
| Temperature | (weight | butylene oxide (ppm/hr) |
| 35 degrees | 0.1 | 1 |
| Centigrade | 2 | 5 |

While the present invention has been described in terms of one or more embodiments, it is to be understood that other modifications may be made without departing from the scope of the invention, which is set forth in the claims below.

What is claimed is:

1. A solvent composition comprising:
a. about 50 weight percent to about 99 weight percent of n-propyl bromide;
b. about 0.5 weight percent to about 50 weight percent of alcohol; and
c. at least 0.005 weight percent of surfactant.

2. The solvent composition of claim 1 wherein the concentration of n-propyl bromide is about 80 weight percent to about 98 weight percent.

3. The solvent composition of claim 1 wherein the concentration of n-propyl bromide is about 88 weight percent to about 95 weight percent.

4. The solvent composition of claim 1 wherein the alcohol is a monohydric aliphatic alcohol.

5. The solvent composition of claim 4 wherein the alcohol comprises 1-propanol, isopropyl alcohol, 1-butanol, 2-butanol, isobutyl alcohol, tertiary butyl alcohol, 1-heptanol, or 1-hexanol and pentanol.

6. The solvent composition of claim 1 wherein the surfactant comprises a non-ionic surfactant, or a product of reaction between a fatty acid reactant and an amine reactant.

7. The solvent composition of claim 6 wherein the non-ionic surfactant comprises polyoxyethylene alkyl ether, polyoxyethylene sec-alcohol ether or polyoxyethylene alkyl phenyl ether.

8. The solvent composition of claim 6 wherein the non-ionic surfactant is biodegradable.

9. The solvent composition of claim 7 wherein the fatty acid reactant comprises a C₆ to C₁₂-containing aliphatic monocarboxylic acid.

10. The solvent composition of claim 7 wherein the amine reactant comprises C₆ to C₁₂-containing aliphatic monoamines.

11. A method of cleaning an article, the method comprising contacting the article with a solvent composition for removing at least one of water or water soluble contaminants, wherein the solvent composition comprises about 50 weight percent to about 99 weight percent n-propyl bromide, about 0.5 weight percent to about 50 weight percent alcohol, and at least about 0.005 weight percent of a surfactant.

12. A method of removing at least one of water or water soluble contaminants from an article, the method comprising:
a) contacting the article in a sump filled with a solvent comprising:
i. about 50 weight percent to about 99 weight percent n-propyl bromide;
ii. about 0.5 weight percent to about 50 weight percent alcohol; and
iii. at least 0.005 weight percent surfactant;
b) introducing a mixture comprising the solvent, and water or water-soluble contaminants to a tank for separation; and
c) returning the separated solvent to the sump.

13. The method of claim 11 or 12 wherein the alcohol is a monohydric aliphatic alcohol comprising 1-propanol, isopropyl alcohol, 1-butanol, 2-butanol, isobutyl alcohol, tertiary butyl alcohol, 1-heptanol, or 1-hexanol and pentanol.

14. The method of claim 11 or 12 wherein the surfactant comprises a non-ionic surfactant, or a product of reaction between a fatty acid reactant and an amine reactant.

15. The method of claim 14 wherein the non-ionic surfactant comprises polyoxyethylene alkyl ether, polyoxyethylene sec-alcohol ether or polyoxyethylene alkyl phenyl ether.

16. The method of claim 14 wherein the fatty acid reactant comprises a C₆ to C₁₂-containing aliphatic monocarboxylic acid.

17. The method of claim 14 wherein the amine reactant comprises a C₆ to C₁₂-containing aliphatic monoamines, including mixtures thereof.

18. The method of claim 11 or 12 wherein the article comprises a metal product, a glass product, plastics, a polymeric substrate, or an electronic component or article.

19. The method of claim 11 or 12 wherein the method comprises cold cleaning or hot rinsing.
